(19) United States
(12) Patent Application Publication
(10) Pub. No.: US 2005/0203856 A1
(43) Pub. Date: Sep. 15, 2005

(54) Method & system for accelerating financial transactions

(76) Inventor: David Russell, Virginia Beach, VA (US)

Correspondence Address: DAVID RUSSELL, P O BOX 913, VIRGINIA BEACH, VA, 23451, US

(21) Appl. No.: 11/080,749

(22) Filed: Mar. 15, 2005

Related U.S. Application Data
(60) Provisional application No. 60/553,024, filed on Mar. 15, 2004.

(51) Int. Cl. H04L 9/00

(52) U.S. Cl. 705/67

(57) ABSTRACT

Improved, higher speed, security and privacy oriented financial protocols are disclosed for accelerating both “contactless” and “contact” smartcard payments at POS (Point Of Sale) terminals. This simplified protocol greatly improves the speed of secure smartcard transactions while preserving privacy and security. The present invention is adapted to optimize cardholder-initiated, card-based (or card-equivalent-based) transactions with POS terminals, payment machines, and the like. In addition to using contact or contactless smartcard formats, this invention may use infra-red (IR), Bluetooth, or other wireless communications techniques. The invention authenticates and verifies transactions between a card and a POS terminal (or other transactions terminal and/or destination transceiver). Also, the invention provides for cardholder initiation of financial transactions, ensuring that card contents cannot be surreptitiously read without the cardholder's knowledge; this is crucial for wireless devices that might otherwise be remotely accessed by a rogue terminal.

### RELATED APPLICATION

This Application claims priority to Provisional Application 60/553,024 filed Mar. 15, 2004.

### FIELD OF THE INVENTION

The field of the invention is financial transactions protocols, methods and systems, more particularly, methods and systems for accelerating (and increasing security of) card-initiated financial transactions and related message transmissions.

### RELATED ART

There appears to be no directly related and analogous art. There is perhaps one patent that is interesting to note, U.S. Pat. No. 6,393,411 to Bishop. This patent discloses a secure funds device for use with a computer system. One or more electronic cash devices store electronic funds and transfer funds in response to a funds transfer request when authorized by an authorization signal. A processor is used for connecting the funds transfer request from the computer system to the electronic cash device and for transferring electronic funds from the electronic cash device to the computer system when the authorization signal is present. The device of the Bishop patent is essentially a “secure funds device” (as stated) which is actuated by a “pushbutton” actuator or other actuator. In all claims of this patent, the “secure funds device” is referred to. This Bishop invention is unlike the present invention, because it appears to be essentially a vehicle for the transmission of electronic money credits. The present invention is a cardholder and card-initiated purchase request message generator, which first challenges a terminal device. While the present invention can be used to effectuate and generate electronic commerce transactions, it is not per se dedicated to transferring funds. Also the button of the present invention (where implemented, depending on configuration details) is not directly analogous to the pushbutton of the Bishop device, despite that both inventions have actuators and despite that both inventions can generate electronic commerce transactions. Furthermore, the Bishop invention does not have a card initiated terminal challenge transaction, in the manner of the present invention.

### NECESSITY OF THE INVENTION

Consumers expect and demand increasingly faster completions of transactions when making purchases. The current protocols for securely transacting credit card payments take several seconds to complete transaction dialogues and close transactions. This takes more time on the part of consumers and sales clerks, than is necessary.

The conventional, existing approach to POS terminal/cardholder authentication protocols, allows POS terminals to initially and anticipatorily challenge cardholders and cardholder apparatuses (a.k.a. cardholder apparatuses and other transactions-initiating apparatuses, e.g.,tokens, debit cards, credit cards, smartcards, and other end-user apparatuses including transceivers, etc.). With current (e.g., EMV) protocols, POS terminals can access data on the user's card without the user first authorizing the POS terminal access and without the user even being aware that such access has occurred. By contrast, in the present invention, the privacy of the user (and privacy of their card) is protected because the method of the invention does not allow POS terminal communications with the card unless and until the user and the user's card have voluntarily and explicitly initiated a financial transaction.

It appears there are few (if any) products currently on the market allowing cardholders and cardholder transactions apparatuses to initially and anticipatorily authenticate, verify, and validate the identities of “interrogating” POS terminals (and/or other transactions-authenticating terminal apparatuses) before cardholders/cardholder apparatuses authenticate the “unproven” POS terminal apparatuses and their subsequent transmissions. Accordingly, what's needed in the art, is a card-initiated authentication protocol method (unlike the current EMV protocol) that allows cardholders and card apparatuses, to initially “self-authenticate” while efficiently and effectively challenging, authenticating, and verifying their chosen destination financial transaction terminal (e.g., a POS terminal or the like).

### OBJECTS OF THE INVENTION

A primary object of the invention is to increase transaction speeds so that cardholders and sales personnel can save substantial amounts of time when carrying out transactions; i.e., the invention provides a method for making a cardholder-authentication-governed transaction authentication protocol operate at speeds up to 400% faster than conventional financial transaction protocols and other protocols. For example, the so-called EMV protocol may be insufficiently fast when compared to the present invention, and thereby potentially inconvenient and/or impractical for applications where speed is critical.

It is another object of the invention to improve the privacy of the transaction and protect the user's card from unauthorized access, by requiring that the user's card initiate the transaction so that the card cannot be accessed without explicit user permission. This can be achieved by creating a cardholder/cardholder apparatus-initiated method for authenticating POS transceiver devices (and other financial and POS terminal devices). This procedure allows users to have the “first and last say” in financial protocols involving authentication sequences.

It is a related primary object, to allow POS terminals to be authenticated and verified by cardholders and cardholder apparatuses (e.g. hardware tokens—such as smartcards, debit and credit cards—and/or other cardholder financial transactions devices).

### SUMMARY OF THE INVENTION

The invention allows end user cardholders—by means of their own card devices—to authenticate POS terminal devices and other financial terminal machinery, in a way substantially different from the existing EMV (Europay Mastercard Visa) protocol. The EMV protocol is often used for authenticating user transmissions to POS terminal devices. By contrast, the present invention performs authentication of the parties to a prospective transaction at the same time that it also transfers the message data necessary to carry out the transaction. If both the authentications are successful—both the card device and the financial transaction terminal device—then the exchanged authentication data and transactions data sent between devices can be used to complete the transaction (assuming the account has sufficient funds). Only three sets of messages—a Purchase Request Message; an Invoice Message; and an Acknowledgement Message, each comprising a series of data packets—need to be transmitted to effectuate a financial transaction, greatly reducing the time required to perform the transaction.

The present invention teaches that the cardholder apparatus (a card, token, etc.) initially challenges the POS terminal with a randomized challenge and a Purchase Request, comprising a Purchase Request Message. Next, in response to the challenge, the financial transaction terminal (e.g., a POS terminal) returns an authenticated reply within a responsive invoice, together comprising an Invoice Message. Next, the card apparatus (e.g., smartcard, transceiver, etc.) validates and authenticates the Invoice Message reply and sends back a card apparatus-authenticated response to the financial transaction terminal where it is yet again validated.

In summary, the present invention teaches that the card device challenges the financial transaction terminal (e.g., a POS terminal or other terminal device) with a randomized challenge. The terminal then returns an authentication reply; the cardholder apparatus then validates the terminal authentication reply (included in the Invoice Message) and sends an authenticated response to the financial transaction terminal.

### BRIEF DESCRIPTION OF TABLES, DRAWINGS, & SYMBOLS

FIG. 1 shows user-operated card (or token) device 102 and financial transaction terminal 104

FIG. 2 shows a summary message format of Purchase Request Message

FIG. 3 shows a summary message format of Invoice Message

FIG. 4 shows a summary message format of Acknowledgement Message

FIG. 5 shows payment transaction flows from Initiation through Bank Accept/Decline

Table 1A shows total bytes for Purchase Request, Invoice, and Acknowledgement Messages

Table 1B estimates propagation delays for present invention contact and contactless transactions

### REFERENCE NUMERALS

102 Cardholder's Card (or other cardholder apparatus, e.g., a token device)

104 Financial Transaction Terminal (e.g., POS machine)

106 Card Authority/Financial Intermediary (e.g., Bank, Card Association, etc.)

### GENERAL DESCRIPTION OF ONE PREFERRED EMBODIMENT

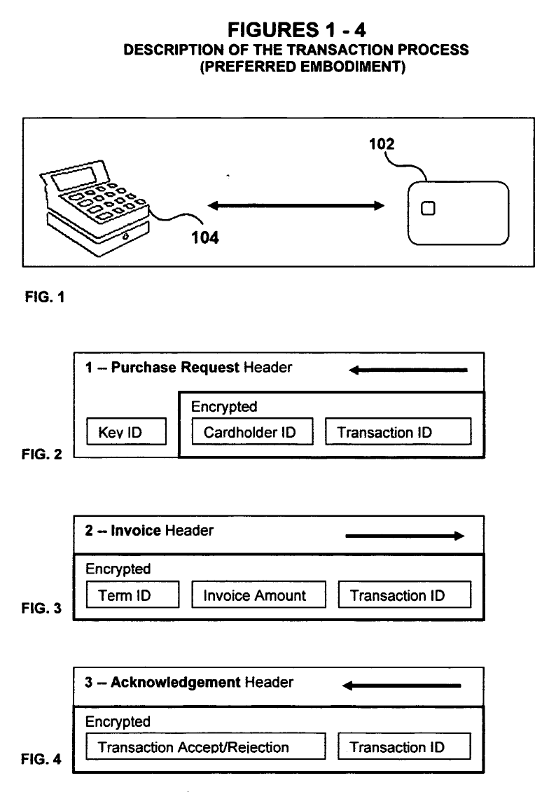

In a first preferred embodiment of the invention—referring now to FIGS. 1 through 4—a cardholder initiates a request to purchase an item either by pressing a button (not shown), or by pressing multiple buttons in a sequence on a keypad (not shown), or by pressing a pre-enrolled finger on a biometric sensor (not shown) or pressing and actuating another triggering device (not shown) situated on a card device of the present invention.

Referring now to the message shown in FIG. 2, the cardholder device 102 generates a purchase request message that serves to request a financial transaction. The format of the purchase request message can be either wirelessly transmitted (e.g., by Bluetooth; IR; RF; etc.) by a contactless card or device, or the purchase request can be directly transmitted via a contact type card. The purchase request message includes a (self-authenticating) message that can be validated by a financial transaction terminal, including: a predetermined purchase request header; an encryption Key ID; and the encrypted concatenation of the identity Cardholder ID plus a unique time-varying Transaction ID. The cardholder device 102 then transmits the purchase request message. The message is received by terminal 104 and is validated and verified by terminal 104. The validity of the purchase request message is determined by decrypting it under the indicated key and comparing the predetermined portion of the verifiable message with a copy of the message.

Referring now to the message shown in FIG. 3, terminal 104 has generated an invoice message including a predetermined invoice header containing: the identity of terminal 104 expressed as a Terminal ID; an Invoice Amount (and Currency Denominator); and the original time-varying Transaction ID that was received from cardholder device 102, with all three items presented as a single encrypted item. The terminal 104 then transmits the encrypted invoice message to cardholder device 102, and device 102 subsequently verifies that the invoice message—after decryption—contains the expected transaction ID (i.e., the original time-varying Transaction ID received from device 102).

Looking now at the message illustrated in FIG. 4, an acknowledgement message is shown. Specifically, cardholder device 102 generates an encrypted acknowledgement message including a header which acknowledges the acceptance or rejection of the transaction and includes the original Transaction ID. Both items are together presented as a single encrypted item and are subsequently transmitted back to financial terminal 104. The terminal 104 verifies that decrypted acknowledgement message contains an acceptance/rejection indication, plus, the original Transaction ID. If this condition is met, then the cardholder's account with the banking institution is charged for the transaction.

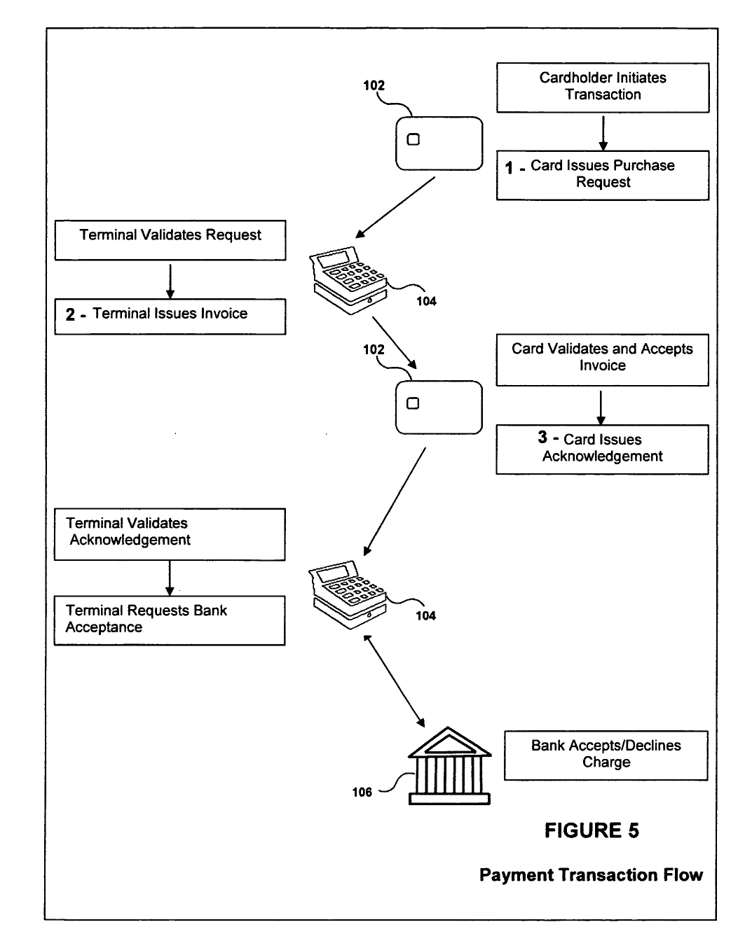

Referring now to FIG. 5, card 102 issues a purchase request message and contained within that request is a time-varying challenge which can comprise an encrypted counter or any other time-varying parameter (a.k.a., a “Card TVP”). The terminal 104 validates the purchase request message, and issues an encrypted invoice message which includes the original time-varying number along with a time-varying challenge (a.k.a., a “Terminal TVP”) from the terminal 104 to the card 102. At this point, the card 102 receives the invoice message and validates it by cryptographically checking the card TVP against the one which the was originally transmitted at the beginning of this transaction. Next, the card 102 generates acknowledgement data including the Terminal TVP and encrypts this information for return to the terminal 104 as an acknowledgement message. The terminal 104 then cryptographically verifies that the Terminal TVP that was received from card 102 matches the Terminal TVP sent to the card 102 for this transaction. At that point, if these steps are successful, then the full handshaking process has been successfully and securely completed, and the terminal 104 is fully in possession of necessary data and information to submit the transaction the bank and/or financial intermediary for funding thereof.

Transaction Processing Speed Discussion/EMV Transaction Speed

Current implementations of EMV (Europay, Mastercard, Visa) protocols require up to 12 seconds from the time that a contact-type smartcard is inserted into the POS equipment, until the time that it is withdrawn from the POS equipment.

Notably, the fastest EMV transactions recorded require about 8.4 seconds, e.g., as reported and chronicled at www.trintech.com in reference to “time trials” of January 2003. For additional info, see also: http://www.trintech.com/NAE213122241451005836515NDBQ22JAN03A.html

Also notably, contactless smartcards take even longer than contact smartcards, because of power limitations on their cryptographic processing capability. Most such delays are due to the EMV requirement to perform PKI (“public key infrastructure” cryptography) using mathematical exponentiation using large numbers. The rest of the time is taken up by making many transfers using primitive smartcard commands with large amounts of data.

While the EMV protocol is expected by its' providers to be an improvement in speed to complete an electronic transaction, when compared to tendering of cash to a cashier—given the cashier's manual payment amount entry and subsequent change-making (averaging 15 to 30 seconds)—it can be observed that neither the speed of EMV protocol-based payment options, nor the speed of the cash payment options—are “fast” at all, let alone optimized for high volume, fast-moving electronic commerce transactions where speed expectations are extremely high. By like reasoning, it's easy to observe, EMV protocol-based payment options also appear comparably NOT “fast” at all, compared to cash, let alone optimized for micro-payments, typically exemplified by vending machine applications, parking meter applications, coin payphone applications, etc. (To better visualize and consider this, just look uninterruptedly at a watch for 15 seconds or more, to imagine waiting that long for a card to be processed before the vending cycle begins.).

Other ideas and variations on the present invention may become apparent to those skilled in the art after reviewing this application. Only a few versions of this present invention are described herein; not all variations and combinations possible are stated. It should also be noted that the present invention requires one or more software programs to execute on both the card of the present invention and the financial transaction terminal of the present invention.

Transaction Processing Speed Discussion/Transaction Speed of this Invention

The protocol of the method of my invention greatly reduces the transaction time by reducing the number of transaction steps and simplifying the required cryptography. The symmetrical key cryptography reduces the processing time to 17 ms per 8 byte block and the shorter packets reduce the transaction delivery time. The result is transaction completion in less than one-half second (i.e. about 475,000 microseconds) if errors or retries are not present. The complete transaction can be performed within one second even when on-token biometrics are employed.

TABLE 1A
Purchase Request

| | |
|---|---|
| Header | 3 |
| Key ID | 4 |
| Cardholder ID | 8 |
| Transaction ID | 4 |
| MAC | 4 |
| Total bytes | 23 |

Invoice

| | |
|---|---|
| Header | 3 |
| Terminal ID | 4 |
| Invoice Amount | 5 |
| Transaction ID | 4 |
| MAC | 4 |
| Total bytes | 20 |

Acknowledgement

| | |
|---|---|
| Header | 3 |
| Accept/Reject code | 1 |
| Transaction ID | 4 |
| MAC | 4 |
| Total bytes | 12 |

TABLE 1B

| | Total | Contact | | Contactless | |
|---|---|---|---|---|---|
| Transaction Segments | Bytes | Delay | | Delay | |
| Encrypt | 23 | 51 | | 51 | |
| Purchase Request | | | | | |
| Transmit | 23 | 24 | | 1 | |
| Purchase Request | | | | | |
| Decrypt | 23 | 51 | | 51 | |
| Purchase Request | | | | | |
| Encrypt Invoice | 20 | 51 | | 51 | |
| Transmit Invoice | 20 | 21 | | 1 | |
| Decrypt Invoice | 20 | 51 | | 51 | |
| Encrypt | 12 | 34 | | 34 | |
| Acknowledgement | | | | | |
| Transmit | 12 | 13 | | 1 | |
| Acknowledgement | | | | | |
| Decrypt | 12 | 34 | | 34 | |
| Acknowledgement | | | | | |
| Decision Making | | 2 | | 2 | |
| Total | 165 | 332 | | 277 | |
| Add Biometric | | 500 | | 500 | |
| Authentication | | | | | |
| Total | | 832 | ms | 777 | ms |

1. A method for accelerating financial transactions initiated by a cardholder and a card, comprising the steps of
[1] transmitting from said card to a financial transaction terminal, a combined purchase request message including a cryptographic authentication of said card to said financial transaction terminal;
[2] responding by said financial transaction terminal to said purchase request message, with a terminal-initiated invoice message including a cryptographic authentication of said terminal to said card;
[3] responding by said card to said terminal-initiated invoice message, with a card acknowledgement message comprising a final authentication exchange including a purchase confirmation and a final authorization of said transaction; and
[4] charging said cardholder's account after all authentication and acknowledgement steps succeed and after a card authority/financial intermediary reports that a proposed charge is accepted.

2. A system for securing transactions using a card-based program executing on a card apparatus and a terminal-based program executing on a terminal apparatus to effectuate a bilateral communications dialogue therebetween, the system comprising:
[1] said card apparatus including said card-based program executing to initiate a purchase request message comprising a combined purchase request message including a cryptographic authentication of said card to said terminal;
[2] said terminal apparatus including said terminal-based program executing in response to said purchase request message by transmitting an invoice message including a cryptographic authentication of said terminal to said card; and
[3] at least one card authority/financial intermediary.

3. The method of claim 1, wherein said card decrypts said invoice message from said terminal and verifies that said invoice message includes valid identification of said terminal.

4. A card apparatus for generating and transmitting a card-initiated purchase request message to a financial transaction terminal, wherein said purchase request message includes an identification challenge to said financial transaction terminal.

5. The purchase request message of claim 4, further comprising a purchase request message header, a key ID, and an encrypted cardholder ID and transaction ID.

6. The encrypted cardholder ID and transaction ID of claim 5, wherein said encrypted cardholder ID and said transaction ID are encrypted prior to transmission thereof.

7. A terminal apparatus for generating and transmitting an invoice message in response to a card-initiated purchase request message including a terminal identification challenge, wherein said invoice message includes a response to said terminal identification challenge and further includes an identification challenge to said card.

8. A system for card-based initiation of a purchase request including an identification challenge to a financial transaction terminal, comprising at least one card apparatus, at least one financial transaction terminal, at least one method for conducting financial transactions, and at least one card authority/financial intermediary.

9. The card apparatus of claim 4, wherein said card apparatus is further adapted to visually display a purchase transaction amount after receipt of an invoice message from a financial transaction terminal.

10. The card apparatus of claim 4, wherein said card apparatus is further adapted to require at least one authentication input from a cardholder.

11. The card apparatus of claim 10, wherein said at least one required authentication input comprises at least one cardholder biometric input.

12. The card apparatus of claim 10, wherein said at least one required authentication input comprises at least one cardholder PIN.
